(19) United States
(12) Patent Application Publication
(10) Pub. No.: US 2007/0027844 A1
(43) Pub. Date: Feb. 1, 2007

(54) Navigating recorded multimedia content using keywords or phrases

(75) Inventors: Stephen H. Toub, New York City, NY (US); Derek T. Del Conte, Sammamish, WA (US)

Correspondence Address: Rick Nydegger;Workman Nydegger, 60 East South Temple, 1000 Eagle Gate Tower, Salt Lake City, UT, 84111, US

(73) Assignee: Microsoft Corporation, Redmond, WA (US)

(21) Appl. No.: 11/191,400

(22) Filed: Jul. 28, 2005

(51) Int. Cl. G06F 17/30

(52) U.S. Cl. 707/3

(57) ABSTRACT

Example embodiments allow a user to search for keywords or phrases within a recorded multimedia content (e.g., songs, video, recorded meetings, etc.), and then jump to those positions in the video or audio where the keyword or phrase occurs. A transcription index file is generated that includes searchable text with time codes corresponding to portions of the multimedia content where dialog, monolog, lyrics, or other words occur. Accordingly, a user can search the transcription index file, receive snippets of the dialog, monolog, lyrics, or other words, and/or navigate to those portions of the multimedia content corresponding to the times where the keywords or phrases appear. In addition, the present invention also provides metadata of the transcription index file that will allow a user to locate a multimedia file that contains the keywords or phrases even when a user has numerous multimedia files.

### CROSS-REFERENCE TO RELATED APPLICATIONS

N/A

### BACKGROUND

Many rendering devices and systems are currently configured to consume multimedia content (e.g., video, music, text, images, and other audio and visual content), in a user-friendly and convenient manner. For example, some Video Cassette Recorders (VCRs), Programmable Video Recorders (PVRs), Compact Disc (CD) devices, Digital Video Disc (DVD) devices, Digital Video Recorders (DVRs), and other rendering devices are configured to enable a user to fast-forward, rewind, or skip to desired locations within a program to render the multimedia content in a desired manner.

The convenience provided by existing rendering devices and systems for navigating through multimedia content, however, is somewhat limited by the format and configuration of the multimedia content. For example, if a user desires to advance to a particular point in a recorded program on a video cassette, the user typically has to fast-forward or rewind through certain amounts of undesired content. Even when the recorded content is stored in a digital format, the user may still have to incrementally advance through some undesired content before the desired content can be rendered. The amount of undesired content that must be advanced through is typically less, however, because the user may be able to skip over large portions of the data with the push of a button.

Some existing DVD and CD systems also enable a manufacturer to determine and index the multimedia content into chapters, scenes, clips, songs, images and other predefined audio/video segments so that the user can select a desired segment from a menu to begin rendering the desired segment. Although menus are more convenient than incrementally browsing through undesired content, existing navigation menus are somewhat limited because the granularity of the menu is constrained by the manufacturer rather than the viewer, and may, therefore, be somewhat course. Accordingly, if the viewer desires to begin watching a program in the middle of a chapter, the viewer still has to fast-forward or rewind through undesired portions of the chapter prior to arriving at that desired starting point.

Yet another problem with certain multimedia navigation menus is that they do not provide enough information for a viewer to make an informed decision about where they would like to navigate. For example, if the navigation menu comprises an index listing of chapters, the viewer may not have enough knowledge about what is contained within each of the recited chapters to know which chapter to select. This is largely due to the limited quantity of information that is provided by existing navigation menus.

Another known disadvantage with navigating through multimedia content is experienced when multimedia content is recorded from a broadcast (e.g., television, satellite, Internet, etc.), since broadcast programs typically do not include menus for navigating through the broadcast content. For example, if a viewer records a broadcast television program, the recorded program does not include a menu that enables the viewer to navigate through the program.

Nevertheless, some PVRs enable the user to skip over predetermined durations of a recorded broadcasted program. For example, a viewer might be able to advance thirty minutes or some other duration into the program. This, however, is blind navigation at best. Without another reference, simply advancing a predetermined duration into a program does not enable the user to knowingly navigate to a desired starting point in the program, unless the viewer knows exactly how far into the program the desired content exists.

More recently, systems have been created to provide a transcription file of dialog, monolog, lyrics, or other words within multimedia content. This transcription file can be viewed by a user and manually sorted through, wherein the user associates tokens with various portions of the transcription. Each token assigned within the transcription file has a time stamp associated with it, such that a user can subsequently choose those sections that he wishes to fast-forward or rewind to within a multimedia content environment by simply clicking on or otherwise activating the token.

Although these systems allow for finer grained navigational control for multimedia content, there are still several drawbacks and disadvantages of such navigation mechanisms. For example, in order to navigate to a desired section a user must manually sift through the entire transcription of the multimedia content and determine those portions of the multimedia content to tag with a token. A user, however, may be uncertain as to what portions of the multimedia content to tag with a token for future navigation. In addition, when the user wishes to advance to a specific section in the multimedia content, the user is again presented with the entire transcription and must still manually look for tokens that were previously assigned to those areas of interest. Often times, however, a user may only remember a keyword or phrase within the multimedia content, but not know which multimedia recorded content contains such keywords or phrases and/or where within the multimedia content such keywords or phrases appear.

Another deficiency of token driven navigational systems is that they do not allow for “live” searching of streaming multimedia content. In other words, because the content must be fixed in a recorded medium in order to allow a user to manually assign tokens, the content has to be marked-up after the recording. As such, live multimedia content cannot be navigated through on-the-fly until the entire program has been recorded and portions thereof manually assigned tokens.

Still another drawback with these token driven navigational tools is that they don't allow for a user to automatically search and view small portions or snippets of the multimedia content. Because a user must manually sift through the entire transcription file, there is no way to automatically jump to and view snippets of those portions of multimedia content desirable. Accordingly, if one recorded a broadcast throughout the day (e.g., news multimedia content), but desired to only view those portions that were directed to a specific topic of interest (e.g., stock quotes); the user must still manually browse through the transcription file to determine those areas of interest.

### SUMMARY

The above-identified deficiencies and drawbacks of current multimedia navigation mechanisms are overcome through exemplary embodiments of the present invention. Please note that the summary is provided to introduce a selection of concepts in a simplified form that are further described below in the detailed description. The summary, however, is not intended to identify key or essential features of the claimed subject matter, nor is it intended to be used as an aid in determining the scope of the claimed subject matter.

In one example embodiment, methods, systems, and computer program products are provided for navigating through recorded multimedia content by searching for keywords or phrases within the multimedia content. One or more keywords are received as user input when requesting a search for multimedia content that includes the one or more keywords within dialog, monolog, lyrics, or other words for the multimedia content. A transcription index file is then accessed, which includes searchable text data with corresponding time codes for one or more time periods within the dialog, monolog, lyrics, or other words for the multimedia content. A search engine can then be used to automatically scan the transcription index file and return results that include a portion of the dialog, monolog, lyrics, or other words that correspond to the one or more to keywords.

In another example embodiment, methods, systems, and computer program products are provided for searching for recorded multimedia content by utilizing searchable metadata that was transcribed from dialog, monolog, lyrics, or other words within the multimedia content. Similar to before, one or more keywords are received as user input when requesting a search for multimedia content from among a plurality of multimedia files, wherein each of the plurality of multimedia files includes multimedia content used for consumption at a playing device. Thereafter, metadata for each of the plurality of multimedia files is accessed, wherein the metadata for each of the plurality of multimedia files includes searchable text of the dialog, monolog, lyrics, or other words of the multimedia content within each of the plurality of multimedia files. A search engine is used to automatically scan the metadata for each of the plurality of multimedia files. The multimedia content from among the plurality of multimedia files that includes the one or more keywords can be returned for rendering at least a portion of the multimedia content at the playing device.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a multimedia system that utilizes a transcription index file to navigate through multimedia content in accordance with example embodiments;

FIG. 1B illustrates a multimedia center that can generate a transcription index file using a closed captioning stream in accordance with example embodiments;

FIG. 1C illustrates an example user interface that displays results of a multimedia search in accordance with example embodiments;

FIG. 2A illustrates a flow diagram of a method of navigating through recorded multimedia content in accordance with example embodiments;

FIG. 2B illustrates a flow diagram of a method of searching for recorded multimedia content in accordance with example embodiments; and

FIG. 3 illustrates an example computing system that provides a suitable operating environment for implementing various features of present invention.

### DETAILED DESCRIPTION

The present invention extends to methods, systems, and computer program products for navigating through and searching for multimedia content. The embodiments of the present invention may comprise a special purpose or general-purpose computer including various computer hardware or modules, as discussed in greater detail below.

Exemplary embodiments of the present invention allow a user to search for keywords or phrases within a recorded multimedia content (e.g., songs, video, recorded meetings, etc.), and then jump to those positions in the video or audio where that keyword or phrase occurs. A transcription index file is generated that includes searchable text for the dialog, monolog, lyrics, or other words within the multimedia content. Time codes are associated with various portions of the searchable text corresponding to those portions of the multimedia content in which the dialog, monolog, lyrics, or other words (e.g., the keywords or phrases) appear. Accordingly, a user can search the transcription index file, receive snippets of the dialog, monolog, lyrics, or other words, and/or navigate to those portions of the multimedia content corresponding to the times where the keywords or phrases occur. In addition, the present invention also provides metadata of the transcription index file that will allow for locating a multimedia file that contains the keywords or phrases even when a user has numerous multimedia files.

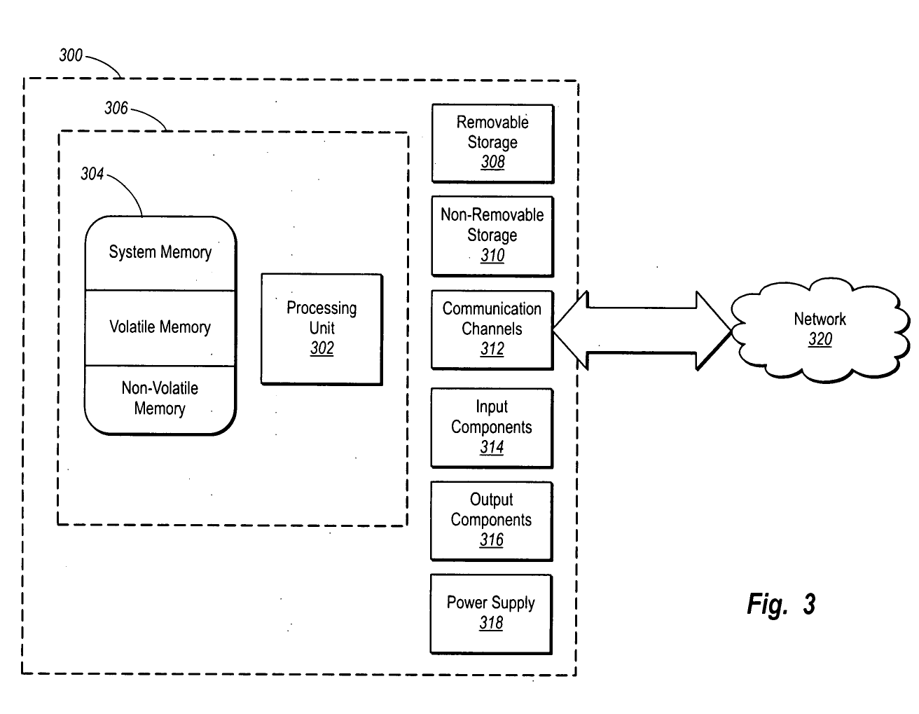

Prior to describing further details for various embodiments of the present invention, a suitable computing architecture that may be used to implement the principles of the present invention will be described with respect to FIG. 3. In the description that follows, embodiments of the invention are described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the principles of the invention are being described in the foregoing context, it is not meant to be limiting as those of skill in the art will appreciate that several of the acts and operations described hereinafter may also be implemented in hardware.

Turning to the drawings, wherein like reference numerals refer to like elements, the principles of the present invention are illustrated as being implemented in a suitable computing environment. The following description is based on illustrated embodiments of the invention and should not be taken as limiting the invention with regard to alternative embodiments that are not explicitly described herein.

FIG. 3 shows a schematic diagram of an example computer architecture usable for these devices. For descriptive purposes, the architecture portrayed is only one example of a suitable environment and is not intended to suggest any limitation as to the scope of use or functionality of the invention. Neither should the computing systems be interpreted as having any dependency or requirement relating to any one or combination of components illustrated in FIG. 3.

The principles of the present invention are operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing system 300 typically includes at least one processing unit 302 and memory 304. The memory 304 may be volatile (such as RAM), non-volatile (such as ROM, flash memory, etc.), or some combination of the two. This most basic configuration is illustrated in FIG. 3 by the dashed line 306. In this description and in the claims, a “computing system” is defined as any hardware component or combination of hardware components capable of executing software, firmware or microcode to perform a function. The computing system may even be distributed to accomplish a distributed function.

The storage media devices may have additional features and functionality. For example, they may include additional storage (removable and non-removable) including, but not limited to, PCMCIA cards, magnetic and optical disks, and magnetic tape. Such additional storage is illustrated in FIG. 3 by removable storage 308 and non-removable storage 310. Computer-storage media include volatile and non-volatile, removable and non-removable media implemented in any method or technology for storage of information such as computer-readable instructions, data structures, program modules, or other data. Memory 304, removable storage 308, and non-removable storage 310 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing system.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of hardware and software are also possible and contemplated. In this description, a “computing entity” may be any computing system as previously defined herein, or any module or combination of modulates running on a computing system.

Computing system 300 may also contain communication channels 312 that allow the host to communicate with other systems and devices over, for example, network 320. Communication channels 312 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The computing system 300 may also have input components 314 such as a keyboard, mouse, pen, a voice-input component, a touch-input device, and so forth. Output components 316 include screen displays, speakers, printer, etc., and rendering modules (often called “adapters” ) for driving them. The computing system 300 has a power supply 318. All these components are well known in the art and need not be discussed at length here.

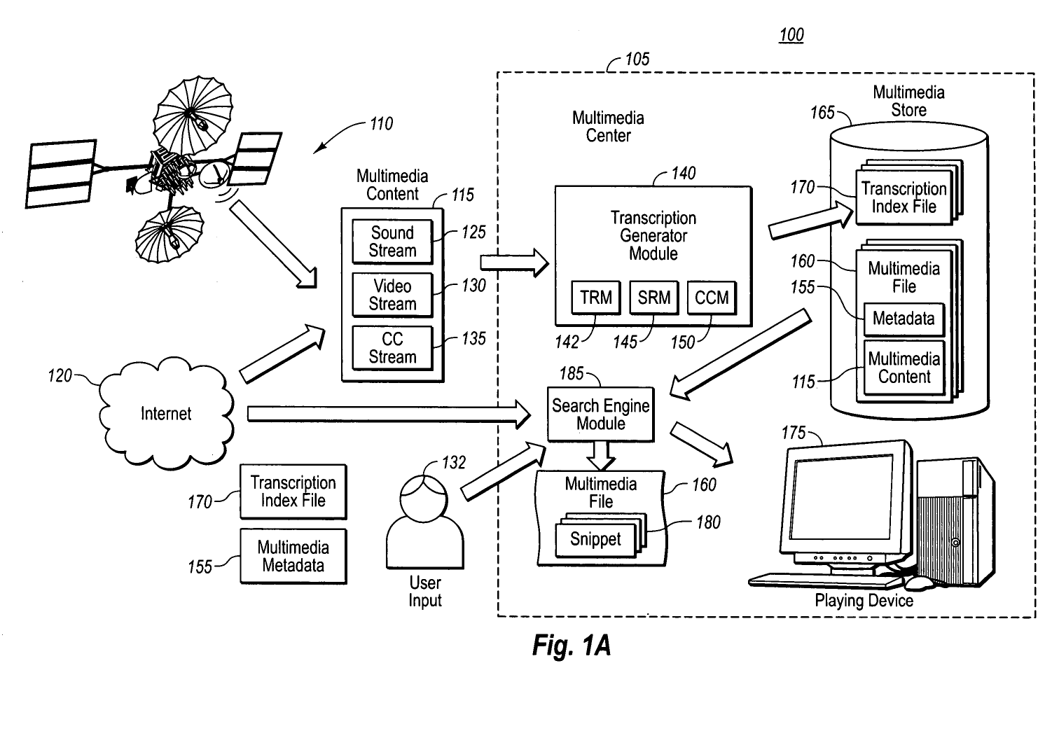

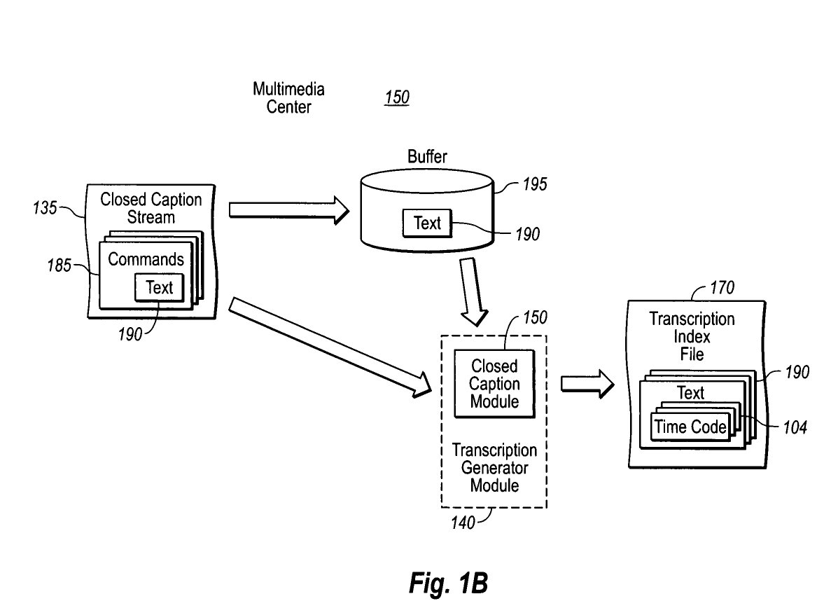

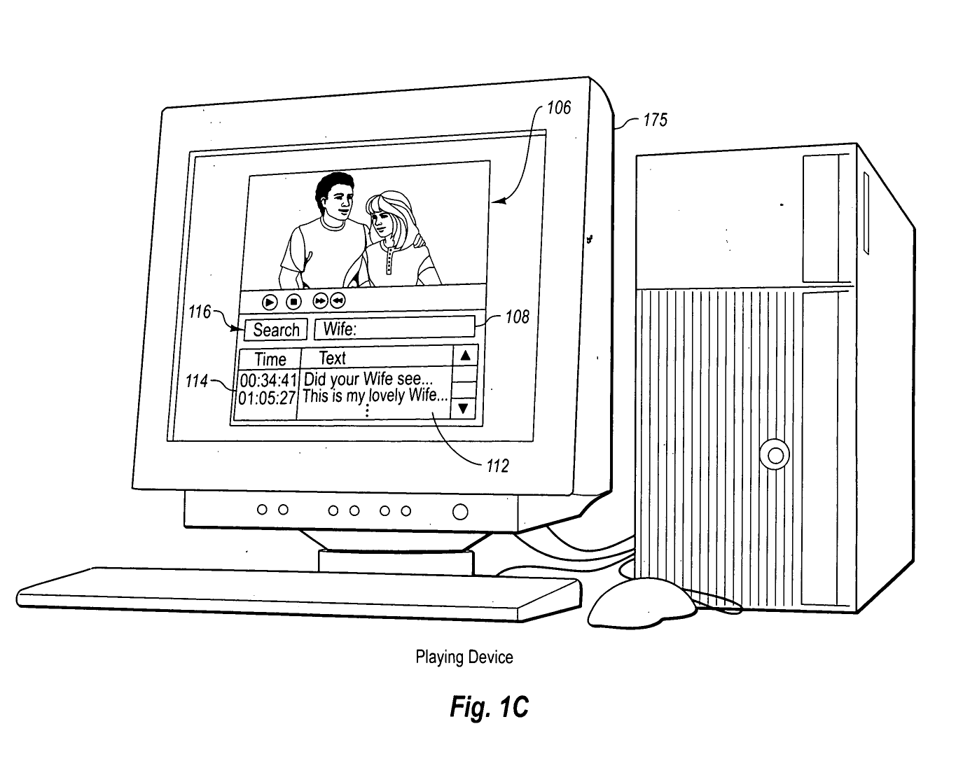

FIG. 1 illustrates a multimedia system 100 that utilizes transcription index files 170 for navigating through multimedia content 115 in accordance with exemplary embodiments. The multimedia system 100 may be similar to the computing system 300 described above with respect to FIG. 3, although that need not be the case. As shown in FIG. 1A, multimedia system 100 includes a multimedia center 105 that is able to receive multimedia content 115 for consumption. The multimedia content 115 may be received from a broadcast station 110 (e.g., television, satellite, etc), a server over the Internet 120 or other computing device and network, a storage media (e.g., magnetic diskette, compact disk, digital video disk, optical disk, and so fourth), or any other medium configured to transmit multimedia content to the multimedia center 105.

The multimedia content 115 (e.g., sound stream 125, video stream 130, and closed captioning (cc) stream 135) will need to be in a fixed medium or otherwise recorded or consumed. (Note that the terms “recorded”, “consumed”, and “rendered” are used herein interchangeably where appropriate). Typically, each stream 125, 130, 135 within the multimedia content 115 will be recorded as separate portions. Accordingly, as described in greater detail below, the closed captioning stream 135, video stream 130, and/or sound stream 125 may be used to create a transcription index file 170. Note, however, that the multimedia content 115 need not include all the streams shown for sound 125, video 130, and closed captioning 135. In fact, the multimedia content 115 may include any combination of audio and video as well as metadata, sideband data, or other data corresponding to the audio and video data. In addition, the multimedia content may be delivered via different multimedia channels (e.g., lyrics with timestamps delivered separate from a musical stream). As such, the following description of multimedia content with any specific reference to one or more stream portions, other data, or a particular transport is used herein for illustrative purposes only and is not meant to limit or otherwise narrow the scope of the present invention unless explicitly claimed.

Regardless of type of multimedia content 115, multimedia center 105 may extract the various streams, which can be passed to transcription generator module 152 for creating transcription index file 170. Prior to discussing the transcription generator module 152 in detail, it is noted that the topology of the devices and other modules within the multimedia center 105 can be configured in any number of well known ways. Accordingly, the use of any specific topology or configuration of devices and modules as used herein are for illustrative purposes only and are not meant to limit or otherwise narrow the scope of the present invention.

Without regard to the topology of the multimedia center 105, transcription generator module 152 can create a transcription index file 170 that can be stored in the multimedia store 165. (Note that the term “file” may also include an in memory representation of the transcription index for real-time navigation as described herein). As previously mentioned, the transcription index file 170 will include searchable text with corresponding time codes for those periods (or approximate time periods) within the dialog, monolog, lyrics, or other words for the multimedia content 115 for which the text occurs. Briefly noted here, transcription index file 170 may be based on the Speech Recognition Module (SRM) 145, Closed Caption Module (CCM) 150, or Text Recognition Module (TRM) 142 as discussed in greater detail below with regard to FIG 1B. In addition, the transcription index file 170 may be obtained by any other well known way. For example, transcription index file 170 may accompany the multimedia content 115 as predefined data from the producer or manufacture of the multimedia content 115. Accordingly, how the transcription index file 170 is generated is used herein for illustrative purposes only and is not meant to limit or otherwise narrow the scope of the present invention unless explicitly claimed.

Once the transcription index file 170 is generated, a search engine module 185 can be activated by a user when desiring to find keywords or phrases within the multimedia content. Note that search engine module 185 may be any type of well known search engine. For example, the search engine module 185 may be a basic search engine that searches for exact keywords or phrases. Alternatively, the search engine module 185 can be more sophisticated allowing for a plurality of various options when searching the multimedia content 115. Accordingly, any particular search engine module 185 can be used with various aspects and embodiments described herein.

Using the search engine module 185, user input 132 can be received for entering keywords or phrases to search for within the multimedia content 115 and example embodiments provides for a myriad of different results that may occur in response thereto. For example, one embodiment provides that search engine module 185 can scan through the transcription index file 170 and find numerous places where the keywords or phrases occur within the multimedia content 115. In this embodiment, a user may be provided with snippets of the actual text containing the keywords or phrases. This list can then be presented to the user for selecting one of the various snippets for consumption at playing device 175. In other words, each snippet or small portion of the dialog, monolog, lyrics, or other words presented to the user as a list will have a link to a corresponding time code where that content is within the multimedia content 115. Accordingly, the user may select any one of them and jump to that portion of the multimedia content 1 15 using the playing device 175.

Note that example embodiments also allow for jumping to other areas within the multimedia content 115 other than the exact time code associated with desired portion of the multimedia content 115. For example, to ensure that the portion of multimedia content 115 for selection includes all of the desired keywords or phrases, example embodiments allow for jumping to a time code that is a few seconds (or some other time) earlier and/or later in time. Accordingly, the term “time code” should be broadly construed to correspond to an approximate time for where the content is within the multimedia content 115, rather than any specific or exact time code.

In another example embodiment, each of the snippets 180 or portions of the multimedia content 115 that include the keywords or phrases of interest may be automatically played in either a systematical or random ordering. For example, say a user has been recording news stations and/or other multimedia content 115 that was broadcast 110 throughout the day. A user may desire to see snippets 180 of that information of interest. For example, the user may wish to see news reports containing information about a natural disaster such as a hurricane. Accordingly, a user can type in “hurricane” into search engine module 185, wherein the search engine module 185 will scan the transcription index file 170 and find those portions of the multimedia content that contain information about hurricanes. In such instance, each snippet 180 may be played in chronological (or any other order) for a predetermined period of time—that is optionally adjustable. For example, the user may be able to set snippet 180 durations for fifteen seconds and see a brief overview of the events that have occurred for hurricanes throughout the day on a news channel. Of course, analysis of the video, audio, textual content, and/or time codes can also be used to make these snippets 180 variable in length. For example, once a desired location is found, it could be programmed to play until there is a lengthy-enough pause in the audio, a lengthy enough pause between display captions, a black or blank frame in the video, or any other indicator that might signify a change in topic or subject matter.

Other example embodiments provide that during the playing of each snippet 180, the user may lengthen the duration for which the snippet 180 is played by, e.g., clicking on an icon, or other token to extend the play. Of course, other well known methods of navigating through multimedia content 115 are also available in combination with embodiments described herein. For example, a user may skip certain snippets 180 or replay other portions. Accordingly, any other well known ways of navigating multimedia content can be used in combination with various example embodiments provided herein.

In yet another example embodiment, a new multimedia file 160 may also be created for the snippets 180 provided from the search results. These multimedia files 160 may be saved and have their own transcription index files 170 associated therewith for subsequent searching of the snippets 180. In addition, as will be described in greater detail below, the new multimedia files 160 can also include metadata 155 for other searching purposes. Note also that the transcription index files 170 for the snippet 180 multimedia files 160 (as well as for other multimedia files 160 described herein) may be generated from appropriate pieces of original metadata 155 described in greater detail below.

In still another embodiment, once the search engine module 185 locates the keywords or phrases within transcription index file 170, the content may be automatically navigated (i.e., forward or backward) to a time code for which the keywords or phrases correspond. Upon skipping to such section, the multimedia content 115 may be automatically consumed by starting at that point in time. Of course, other well known results provided from being able to search the multimedia content 115 are also available to the present invention. For example, rather than automatically playing the multimedia content 115 at that point in time, the multimedia center 105 may skip to the beginning of the chapter that contains the keywords or phrases and begin playing the content 115 at that point.

As previously mentioned, another example embodiment provides for creating metadata 155 that includes a transcription of the dialog, monolog, lyrics, or other words for the multimedia content 115 without corresponding time codes. As such, search engine module 185 may search a plurality of multimedia files 160, and in particular the metadata 155 associated therewith, to determine one or more multimedia Mz files 160 that contain the keywords or phrases desired by the user. For example, say a user has numerous multimedia files 160 with multimedia content 115 within their multimedia store 165. Although they may not remember the title of the multimedia content 115, they remember a line from a movie or song. Accordingly, the user can enter the keywords or phrases into the search engine 185, which will then scan the metadata 155 of the various multimedia files 160. Those multimedia files 160 that include the keywords or phrases may then be returned to the user and displayed for selection in a similar manner to that previously described. Of course, if the search engine module 185 is a global search engine (such as a desktop search), other files other then just multimedia files 160 may also be returned that include the keywords or phrases. In addition to returning the multimedia file 160 and other files, metadata such as the closed caption information may also be returned. Of course other metadata associated with the multimedia content 115 and other files may also be returned.

Note that using the metadata 155 to find multimedia content 115 with a particular keyword or phrase can also be used in conjunction with the transcription index file 170. In this embodiment, not only will the multimedia file 160 be found that includes the keywords or phrases, but the actual text and link to such keywords may also be displayed, played, or otherwise presented to the user. Accordingly, the user can easily find the appropriate multimedia content 115 and jump to that section within the multimedia content 115 that corresponds to the keywords or phrases desired.

It should also be noted that the metadata 155 may or may not be generated based upon the transcription file 170. For example, the multimedia metadata 155 may be downloaded from the Internet 120 or accompany the multimedia content 115 when such content is produced. Accordingly, any particular reference to how the metadata 155 is generated as described herein is used for illustrative purposes only and is not meant to limit or otherwise narrow the scope of the present invention unless explicitly claimed.

FIG. 1B illustrates an example of how a transcription index file 170 may be generated using closed captioning stream 135. Since the closed captioning information is stored in an inconvenient format for manipulating as text, it must first be converted to text. The closed captioning instructions or commands 185 may be character information such as text 190 or it can be an be an actual command, such as one to clear the character buffer 195, one to display characters already received, one to change the color of the caption, one to move the curser around on the screen, etc. If the command 185 is a set of characters or text 190, multimedia center 105 adds such text 190 or characters to a current string buffer 195. Using the closed caption module 150 (CCM) from the transcription generator module 140, when an end of caption command 185 or an erase display memory command 185 occurs, the contents of the buffer 195 may be saved as a new closed caption object within the transcription index file 170.

Each text or character object 190 will have associated therewith one or more various time codes 104 for navigation purposes. One time code may be the time at which the first byte of text 190 in a particular caption was sent. Note that it may be awhile before the text is actually displayed to the user, as the bitmap used to display the caption is built up from many commands before finally being rendered. For example, computer systems that support the display of closed caption typically support it by building up bitmaps/images based on the closed caption commands 185 sent along, e.g., with the video stream 130. The closed caption text information 190 is typically received well before it is actually displayed or consumed, due in part to the limited bandwidth available to carry the closed caption data 135—with typically only two characters of closed caption data 135 available per frame. When the appropriate closed caption command 185 is presented, this bitmap is then rendered to the screen as an overlay on the video. Accordingly, the time code 104 associated with this closed caption 135 may not always be an adequate representation of where the actual dialog, monolog, or lyrics are within the multimedia content 115.

Another time associated with the text object 190 within the transcription index file 170 may be the time at which the caption is suppose to actually be rendered to the screen, i.e., when a display command is received from multimedia center 105. This time may also be discovered when an end of caption command is parsed. Because this time typically corresponds to the actual dialog, monolog, or lyric timing, this time will typically be the one associated with the text or character object 190. It should be noted that the present invention is not limited to any specific type of closed caption format. For example, the standard used for NTSC closed captions makes use of end of caption (EOC) commands; however, not all closed caption specifications may do so. Indeed, other specifications may have other mechanisms for indicating the end of a caption or when a caption is to be displayed. Accordingly, any specific reference to a specific type or format of closed captioning is used herein for illustrative purposes and is not meant to limit or otherwise narrow the scope of the present invention unless explicitly claimed.

One more time code 104 that can be associated with the text object 190 may be a time at which the caption should be cleared from the screen. Note that for most purposes, this clear time and the display time are the most important. Regardless, however, of which time codes are associated with the text object 190, once all of the closed caption text objects 190 have been parsed, they are stored in transcription index file 170. This transcription index file 170 may then be exposed through an application program interface to the user as a collection of information that can be used as previously described, or in any other relevant manner.

Note, as previously mentioned, example embodiments allow for real-time searching of the multimedia content 115 as it's being viewed or otherwise consumed, (i.e., allowing a user to search live 110 multimedia content 115 immediately after it is consumed). In this embodiment, the transcription index file 170 can be thought of as an in-memory data object that is capable of being accessed and searched as the closed caption text objects 190 are parsed one-by-one. In other words, a user does not have to wait for all of the closed caption text objects 190 to be parsed, but can immediately navigate to streams that have recently been consumed while the other portions of the multimedia content 115 are still being broadcast and/or otherwise consumed. It is also noted that this real-time navigational tool is also not just limited to closed caption text objects 190, but also extends to other ways of generating a transcription index file 170 as described herein (i.e., using SRM 145 and TRM 142 as described below).

Similar to the embodiments above that use the transcription index file 170 to navigate multimedia content 115, the user interface for embodiments herein can dynamically generate links for each closed captioning text object 190. Based on the associated time codes 104, the links allow users to click on a closed captioning result and skip to the video position within the multimedia content corresponding to the selected caption.

Note that parsing closed caption stream 135 is a relatively slow process. Such closed captioning files 135 and the other streams that include the data (e.g., a video file) can be gigabytes in size and thus it can take anywhere from a few seconds to a few minutes (more or less) to parse all of the closed-caption commands 185 from a closed caption stream 135 file. As such, as previously described, the transcription index file 170 may be cached in multimedia store 165 for future requests. Note, however, that exemplary embodiments provide that such parsing of closed-captioning stream 135 may be done on-the-fly or dynamically as the multimedia content 115 is first being recorded or otherwise consumed (e.g., as in the case of the real-time navigation previously described). Accordingly, the user will typically not notice any delays when they use the searching and navigation capabilities of the present invention. Further, because this transcription index file 170 may be created on-the-fly, a user may immediately (while the multimedia content 115 is still being recorded or otherwise consumed) jump back to portions of the multimedia content 115 as desired in accordance with the search and navigation tools described herein.

Similar to the closed caption module 150 provided above that creates transcription index file 170, a speech recognition module 145 (SRM) may also operate in a similar manner as closed-caption module 150. One notable difference, however, with using the SRM 145 is the granularity at which time codes 104 may be associated with portions of the text 190. For example, the speech recognition module 145 is more dynamic in nature than a closed captioning stream 135, which will typically only renders character or text objects at imprecise intervals. Accordingly, the time codes 104 associated with the text 190 within transcription index file 170 when generated by SRM 145 will usually have a much finer grained series of time codes 104 associated with the various words from the multimedia content 115. In fact, each letter within each word may have a corresponding time code associated therewith when using SRM 145. In order to preserve memory resources, however, this fine of granularity will typically be undesirable. As such, the present invention allows the granularity for assigning time codes 104 to be adjustable depending on the desires of the user.

In addition to creating the transcription index file 170 using closed caption module 150 and/or speech recognition module 145, other example embodiments allow for other words within the multimedia content 115 to be navigated. For example, Text Recognition Module (TRM) 142 can be used to parse through words within frames of video stream 130 to create transcription index file 170. For instance, optical character recognition (OCR) techniques may be used to find words or phrases within text of various scenes of the multimedia content 115—such as words on street signs, building names, text in books being read by the actors, handwritten text on blackboards, words and text on license plates of cars, etc. Similar to the closed caption and speech recognition techniques previously described, the parsed text or other words can have corresponding time codes assigned thereto for searching. It should be noted that other well known ways of searching for text or words within frames of video are also available to the present invention. Accordingly, the use of OCR for parsing other words within multimedia content 115 is used herein for illustrative purposes only and is not meant to limit or otherwise narrow the scope of the present invention unless explicitly claimed.

Note that in another example embodiment of the present invention, all (or a small portion) of the snippets 180 from closed captioning text 190, from snippets 180 generated using CCM 150, SRM 145, and/or TRM 142 can be simultaneously displayed in chronological or other ordering and presented to the user. In other words, the present invention is not limited to just searching and displaying of snippets 180, but may include a navigational tool that allows a user to see all or some of the upcoming or previous snippets 180 of content that is currently or about to be consumed. For example, while a movie is being displayed on playing device 175, snippets 180 of upcoming dialog, monolog, lyrics, or other words may also be displayed along side of the video. The user may scroll through the snippets 180 and jump to those snippets 180 of interest.

FIG. 1C illustrates an example user interface 106, which can be used in practicing various embodiments described above. Note that there are other interfaces with various designs, features, and objects for accomplishing one or more of the functions associated with the example embodiments of present invention. Accordingly, there exists numerous alternative user interface designs bearing different aesthetic aspects for accomplishing these functions. Accordingly, the aesthetic layout of the user interface for FIG. 1C—as well has the graphical objects described therein—are used for illustrative purposes only and are not meant to limit or otherwise narrow the scope of the present invention.

As mentioned above, FIG. 1C includes a user interface 106 of a playing device 175 that shows a screen shot of a particular video file. A keyword “wife” was entered into textbox 108 and a search was requested using search button 116. Note that the user may enter the keywords using any one of any number of well known mechanisms. For example, the user may use a speech recognition mechanism, keypad, remote control, mouse, or any other well known device used in entering information or data for searching.

Regardless of how the text is entered, in accordance with this particular example, the results of the search are presented as a list view 112 as various snippets 180 corresponding to portions of the multimedia content 115 that include the keyword “wife”. Within each row of snippets 180, is an associated time 114 indicating, e.g., a display time in the case of closed captioning. Of course, other times may also be associated with the text for each snippet 180 depending on how the transcription index file 170 is generated. In any event, a user may select a snippet 180 by clicking, double clicking, or any other well known manner of selection, to cause the video to jump to that location. Of course, as previously described, the snippets may automatically play for a set predetermined amount of time in succession or random order, which the user can override. Further, when using the metadata 155, a multimedia file 160 may replace the text snippets 180 within the list 112 for selection in consuming the multimedia content 115 using the playing device 175.

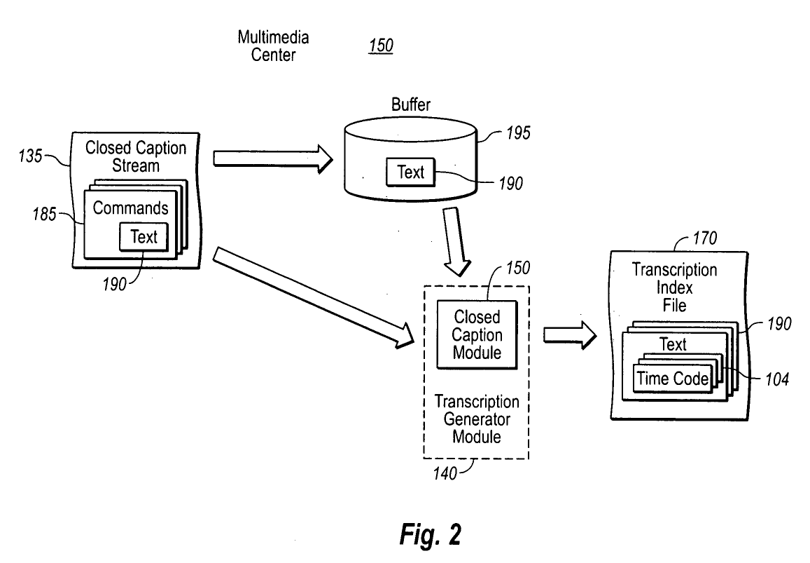

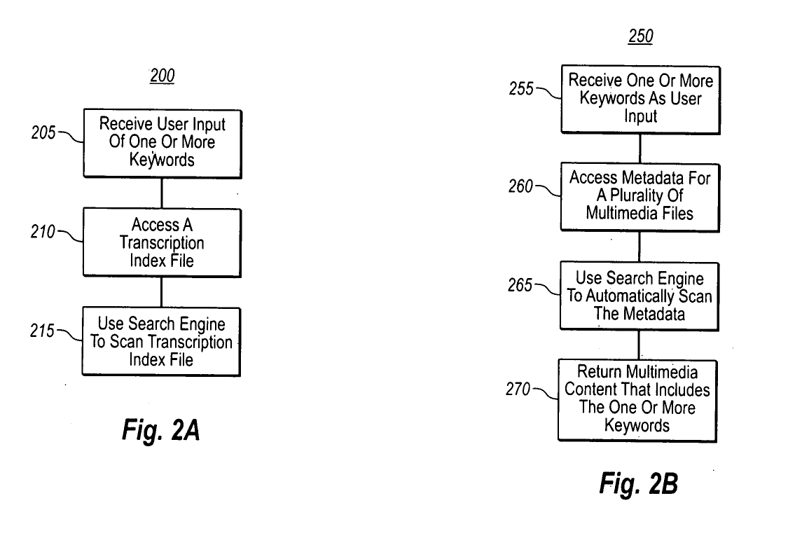

The present invention may also be described in terms of methods comprising functions steps and/or non-functional acts. The following is a description of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts in the recitation of the claims—and in the flowing description of the flow diagrams for FIGS. 2A-B—is used to indicate the desired specific use of such terms.

FIGS. 2A and 2B illustrate flow diagrams for various exemplary embodiments of the present invention. The following description of FIGS. 2A and 2B will occasionally refer to corresponding elements from FIGS. 1A-C. Although reference may be made to a specific element from these Figures, such elements are used for illustrative purposes only and are not meant to limit or otherwise limit narrow the scope of the present invention unless explicitly claimed.

More specifically, FIG. 2A illustrates a flow diagram for a method 200 of navigating through recorded multimedia content by searching for keywords or phrases within the multimedia content. Method 200 includes an act of receiving 205 user input of one or more keywords. For example, a user may input 132 into search engine module 185 various keywords or phrases such as “wife” in textbox 108 when requesting a search 116 of multimedia content 115 that includes the keywords within dialog, monolog, lyrics, or other words for the multimedia content 115.

Method 200 also includes an act of accessing 210 a transcription index file. For example, search engine module 185 may access transcription index file 170 from the multimedia store 165, wherein the transcription index file 170 includes searchable text 190 with corresponding time codes 104 for one or more time periods within the dialog, monolog, lyrics, or other words for the multimedia content 115. The transcription index file 170 may be generated based on: closed captioning data stream 135 using CCM 150; sound stream 125 using SRM 145; video stream 130 using TRM 142; and/or a download file, or other various ways as previously described. Note also that the transcription index file 170 may be generated on-the-fly while the multimedia content is being rendered or otherwise consumed (e.g., recorded) based on one or more of the closed caption data stream 135, sound stream 124, and/or video stream 130 using the CCM 150, SRM 145 and/or TRM 142, respectively.

In the event that the transcription index file 170 is generated based on closed captioning data stream 135, method 200 may further include buffering 195 an amount of text 190 from various commands 185 within the closed caption data stream 135. When a closed caption command 185 is received that is associated with rendering the text 190, the text 190 may be extracted for insertion into the transcript index file 170. Further, one or more time codes 104 may be assigned to the amount of text 190 corresponding to when the closed caption command 185 was received. Note that the closed caption command 185 may be any well known command such as a buffer command, render command, end of caption command, clear screen command, etc.

Method 200 also includes an act of using 215 a search engine to scan the transcription index file. For example, search engine module 185 can be used to scan the transcription index file 170 and return results that include a portion of the dialog, monolog, lyrics, or other words that correspond to the keywords. In accordance with one embodiment, the multimedia content 115 for the portion of the dialog, monolog, lyrics, or other words returned may be automatically played in accordance with the corresponding time code 104. Alternatively, or in conjunction, the results returned may include a list 112 of snippets 180 for the dialog, monolog, lyrics, or other words that include the keywords. Each snippet 180 within the list 112 may include a link to those portions of the multimedia content 115 that correspond to the time codes 104 for such snippet 180. In another embodiment, the plurality of snippets 180 for the multimedia content 115 may each be played for a predetermined period of time, variable period of time, and/or may be recorded into a separate multimedia file 160 with a corresponding transcription index file 170 corresponding to the dialog, monolog, lyrics, or other words within multimedia content of the plurality of snippets 180.

FIG. 2B illustrates a flow diagram for a method 250 of searching for recorded multimedia content by utilizing searchable metadata that was transcribed from dialog, monolog, lyrics, or other words within the multimedia content. Method 250 includes an act of receiving 255 one or more keywords as user input. For example, when requesting a search for multimedia content 115 from among a plurality of multimedia files 160, user input may be received by search engine module 185 for keywords or phrases for multimedia content 115 within the multimedia files 160 used for consumption at the playing device 175.

Method 250 also includes an act of accessing 260 metadata for each of the plurality of multimedia files. For example, multimedia files' 160s' metadata 155 may be accessed, wherein the metadata 155 includes searchable text of the dialog, monolog, lyrics, or other words for the multimedia content 115 within each of the plurality of multimedia files 160. Method 250 further includes an act of using 265 a search engine to automatically scan the metadata. For example, search engine 185 may be used to automatically scan metadata 155 for each of the plurality of multimedia files 160.

Method 250 also includes an act of returning 270 multimedia content that includes the one or more keywords. For example, multimedia content 115 can be returned from among the plurality of multimedia files 160 that includes the one or more keywords. Multimedia content 115 may be presented to a user from a list of other documents or multimedia files 160 and multimedia content 115 that include the keywords for rendering at least a portion of the multimedia content at playing device 175. Note also that the embodiments within method 200 may be incorporated within method 250. Accordingly, those acts identified above with regard to method 200 may equally apply to embodiments within method 250.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a multimedia computing system, a method of navigating through recorded multimedia content by searching for keywords or phrases within the multimedia content, the method comprising acts of:
receiving user input of one or more keywords when requesting a search of multimedia content that includes the one or more keywords within dialog, monolog, lyrics, or other words for the multimedia content;
accessing a transcription index file, which includes searchable text data with corresponding time codes for one or more time periods within the dialog, monolog, lyrics, or other words for the multimedia content; and
using a search engine to automatically scan the transcription index file and return results that include a portion of the dialog, monolog, lyrics, or other words that correspond to the one or more keywords.

2. The method of claim 1, wherein the multimedia content for the portion of dialog, monolog, lyrics, or other words returned is automatically played in accordance with the corresponding time code.

3. The method of claim 1, wherein the results returned include a list of snippets for the dialog, monolog, lyrics, or other words that include the one or more keywords, and wherein each snippet within the list includes a link to those portions of multimedia content that correspond to the time codes for such snippet.

4. The method of claim 1, wherein the transcription index file was generated based on one or more of a closed caption data stream, sound stream, video stream, or a downloaded file.

5. The method of claim 4, wherein the transcription index file is generated based on the closed caption data stream, and wherein the generation comprises acts of:
buffering an amount of text from among a plurality of commands within the closed caption data stream;
receiving a closed caption command associated with rendering the amount of text on a display; and
upon receiving the closed caption command;
extracting the amount of text for insertion into the transcription index file, and
assigning a time code to the amount of text within transcription index file corresponding to when the command to render the amount of text was received.

6. The method of claim 4, wherein the transcription index file is generated on-the-fly while the multimedia content is being consumed based on either the closed caption data stream, sound stream, or video stream.

7. The method of claim 1, wherein the results returned include a plurality of snippets of the multimedia content that include the one or more keywords, and wherein the plurality of snippets are recorded into a separate multimedia file with a corresponding transcription index file corresponding to the dialog, monolog, lyrics, or other words within multimedia content of the plurality of snippets.

8. In a multimedia computing system, a method of searching for recorded multimedia content by utilizing searchable metadata that was transcribed from dialog, monolog, lyrics, or other words within the multimedia content, the method comprising acts of:
receiving one or more keywords as user input when requesting a search for multimedia content from among a plurality of multimedia files, wherein each of the plurality of multimedia files includes multimedia content used for consumption at a playing device;
accessing metadata for each of the plurality of multimedia files, the metadata for each of the plurality of multimedia files including searchable text of the dialog, monolog, lyrics, or other words for the multimedia content within each of the plurality of multimedia files; and
using a search engine to automatically scan the metadata for each of the plurality of multimedia files; and
returning the multimedia content from among the plurality of multimedia files that includes the one or more keywords for rendering at least a portion of the multimedia content at the playing device.

9. The method of claim 8, wherein a plurality of multimedia content from the plurality of multimedia files is returned that includes the one or more keywords, and wherein user input selects the multimedia content from among the plurality of multimedia content for consumption at the playing device.

10. The method of claim 8, wherein the multimedia content is further navigated through by performing a method comprising acts of:
accessing a transcription index file for the multimedia content, which includes searchable text data with corresponding time codes for one or more time periods within the dialog, monolog, lyrics, or other words for the multimedia content; and
using a search engine to automatically scan the transcription index file and return results that include a portion of the dialog, monolog, lyrics, or other words that correspond to the one or more keywords.

11. The method of claim 10, wherein the multimedia content for the portion of dialog, monolog, lyrics, or other words returned is automatically played in accordance with the corresponding time code.

12. The method of claim 10, wherein the results returned include a list of snippets for the dialog, monolog, lyrics, or other words that include the one or more keywords, and wherein each snippet within the list includes a link to those portions of multimedia content that correspond to the time codes for such snippet.

13. The method of claim 10, wherein the transcription index file was generated based on one or more of a closed caption data stream, sound stream, video stream, or a downloaded file.

14. The method of claim 13, wherein the transcription index file is generated based on the closed caption data stream, and wherein the generation comprises acts of:
buffering an amount of text from among a plurality of commands within the closed caption data stream;
receiving a closed caption command associated with rendering the amount of text on a display; and
upon receiving the closed caption command;
extracting the amount of text for insertion into the transcription index file, and
assigning a time code to the amount of text within transcription index file corresponding to when the command to render the amount of text was received.

15. The method of claim 13, wherein the transcription index file is generated on-the-fly while the multimedia content is being consume based on one or more of the closed caption data stream, sound stream, or video stream.

16. In a multimedia computing system, a computer program product for implementing a method of navigating through recorded multimedia content by searching for keywords or phrases within the multimedia content, the computer program product comprising one or more computer readable media having stored thereon computer executable instructions that, when executed by a processor, can cause the multimedia computing system to perform the following:
receive user input of one or more keywords when requesting a search of multimedia content that includes the one or more keywords within dialog, monolog, lyrics, or other words for the multimedia content;
access a transcription index file, which includes searchable text data with corresponding time codes for one or more time periods within the dialog, monolog, lyrics, or other words for the multimedia content; and
use a search engine to automatically scan the transcription index file and return results that include a portion of the dialog, monolog, lyrics, or other words that correspond to the one or more keywords.

17. The computer program product of claim 16, wherein the results returned include a list of snippets for the dialog, monolog, lyrics, or other words that include the one or more keywords, and wherein each snippet within the list includes a link to those portions of multimedia content that correspond to the time codes for such snippet.

18. The computer program product of claim 16, wherein the transcription index file was generated based on one or more of a closed caption data stream, sound stream, video stream, or a downloaded file.

19. The computer program product of claim 18, wherein the transcription index file is generated based on the closed caption data stream, and wherein the computer program product further comprises computer executable instructions that can cause the multimedia computing system to perform the following for generating the transcription index file:
buffer an amount of text from among a plurality of commands within the closed caption data stream;
receive a closed caption command associated with rendering the amount of text on a display; and
upon receiving the closed caption command;
extract the amount of text for insertion into the transcription index file, and
assign a time code to the amount of text within transcription index file corresponding to when the command to render the amount of text was received.

20. The computer program product of claim 18, wherein the transcription index file is generated on-the-fly while the multimedia content is being consumed based on one or more of the closed caption data stream, sound stream, or video stream.
